(19) United States
(12) Patent Application Publication
(10) Pub. No.: US 2023/0142727 A1
(43) Pub. Date: May 11, 2023

(54) METHOD OF MAKING A FIREARM BARREL

(71) Applicant: TRUE VELOCITY IP HOLDINGS, LLC, Garland, TX (US)

(72) Inventors: Lonnie Burrow, Carrollton, TX (US); Kenneth J. Overton, Princeton, TX (US); Christopher William Overton, Wylie, TX (US)

(73) Assignee: TRUE VELOCITY IP HOLDINGS, LLC, Garland, TX (US)

(21) Appl. No.: 17/524,153

(22) Filed: Nov. 11, 2021

(51) Int. Cl. B23D 77/14

(52) U.S. Cl. CPC B23D 77/14; F42B 5/025

(57) ABSTRACT

The present invention provides a method for chambering a barrel of a gun comprising the steps of: providing a chamber reamer comprising a shank extending longitudinally between a front end and a rear end and having a plurality of cutting flutes disposed between the front end and the rear end; a shaft extending to the rear end of the shank and adapted to rotate the shank along an interior of the barrel to form a chamber therein, wherein the shank comprises a body region that extends to a shoulder region that transitions to a case mouth that extends to a throat connected to a free bore, wherein the body region comprises a rear diameter near the breech face of about 0.4718; and a body shoulder junction diameter of about 0.4625; wherein the shoulder region comprises a shoulder case mouth junction diameter is between 0.31 to 0.32; a breech face to lead-in bore junction length of between 2.1 to 2.2; a breech face to body-shoulder junction length of between 1.80-1.85; and a breech face to shoulder neck junction length of between 1.9-2.0; aligning the chamber reamer with a barrel in which a chamber is to be formed; rotating the chamber reamer; and pushing the chamber reamer into the barrel to from a chamber in the barrel.

### TECHNICAL FIELD OF THE INVENTION

The present invention relates in general to the field of automatic or semi-automatic firearms having a barrel having a cartridge chamber in communication with a bore and a reamer for forming a cartridge chamber.

### STATEMENT OF FEDERALLY FUNDED RESEARCH

None.

### INCORPORATION-BY-REFERENCE OF MATERIALS FILED ON COMPACT DISC

None.

### BACKGROUND OF THE INVENTION

Without limiting the scope of the invention, its background is described in connection with cartridge casing, ammunition, a reamer for forming a firing chamber and the chamber in the firearm to receive the ammunition.

A typical firearm includes a barrel, a receiver, and a breech block or bolt. The receiver of the weapon is connected to the barrel having a cartridge chamber and the ammunition is placed into the cartridge chamber in the receiver prior to firing. The ammunition may be loaded into the cartridge chamber manually or automatically, via a magazine. The ammunition is placed in the cartridge chamber so that the bullet faces the entrance to the barrel. The rear end of the ammunition, which houses the primer, faces the bolt or breech block which contains the firing pin and functions to close off the rear end of the ammunition so that when the ammunition is fired, the bullet is ejected from the barrel.

The firearm cartridge for rifles and machine guns, as well as larger caliber weapons, can be made in various calibers or sizes. The firearm cartridge is essential in determining the speed and power of the bullet once the firearm is fired. Generally, bullet speed and power can be affected by many factors including changing the dimensions of the cartridge which dictate the amount of propellant carried by the cartridge. The reliable firearm cartridge require uniformity in manufacturing (e.g., bullet seating, bullet-to-casing fit, casing strength, etc.) to produce consistent pressures within the casing during firing prior to bullet and casing separation to create uniformed ballistic performance. In addition, the chamber in which the firearm cartridge is placed must have uniform and consistent dimensions to produce uniformed ballistic performance.

For example, U.S. Pat. No. 8,011,301 entitled “Cartridge for a firearm” issued to Jimmie Sloan discloses a cartridge case for a firearm is formed to contain a .338 caliber bullet. The case includes a cylindrical body portion with a central aperture in the head end for receipt of a primer and a cartridge extraction groove formed around the periphery of the body portion adjacent the head end. A frustoconical shoulder portion tapers radially inwardly from the body portion and a generally cylindrical neck portion extends longitudinally from the shoulder portion. The length of the body portion is approximately 1.8813 inches and the outside diameter of the body portion at the shoulder portion is 0.5709±0.0059 inches. The length of the shoulder portion is 0.2727 inches. The length of the neck portion is 0.3381 inches and the outside diameter of the neck portion is 0.3669 inches. The case encloses a volume designed to receive an amount of propellant in a range of 82.0 grns to 97.8 grns.

For example, U.S. Pat. No. 9,404,719 entitled “Ammunition cartridge and chamber, and tools for making and reloading same” issued to William R. Bowers discloses a case for an ammunition cartridge including a tubular member having a central axis which includes: a head which includes, a head face which is disposed substantially perpendicular to the central axis, and an extraction groove adjacent to the head face, the extraction groove circumscribing the central axis; a body abutting the head which comprises an internal chamber, a bullet receiving end spaced from the body along the central axis, a convex curved segment abutting the body, the convex curved segment being a first circular curve having a first radius of approximately 0.0263 inches, a frustoconical segment abutting the convex curved segment, and a concave curved segment abutting the frustoconical segment, the concave curved segment being a second circular curve having a second radius of approximately 0.1049 inches. The entire contents of each of which are incorporated herein by reference.

For example, U.S. Patent Application Publication No. 2014/0075805 entitled “Firearm barrel having cartridge chamber preparation facilitating efficient cartridge case extraction and protection against premature bolt failure” issued to Mark C. Lame discloses a barrel to permit ease and efficiency for the extraction of spent cartridge cases from the cartridge chamber of a firearm barrel within a wide range of temperature conditions, the internal tapered surface of the body region of a cartridge chamber by establishing circumferentially spaced longitudinal straight or curved regions of the internal Surface finish to create an internal cartridge chamber geometry having gradually tapered spaced longitudinally relieved linear or spiral areas having longitudinal linear or spiral lands between each of the relieved areas. The circumferentially spaced lands develop controlled impedance to rearward cartridge case movement on cartridge firing to effectively protect the bolt and extractor mechanisms of the firearm against early failure.

### SUMMARY OF THE INVENTION

Accordingly, it is an object of the present invention to provide a new and improved barrel, chamber and reamer to form the chamber for use with a new and improved cartridge for a firearm.

Another object of the invention is to provide a new and improved barrel, chamber and reamer for use with a cartridge for a firearm that maximizes bullet speed, resulting in more down range energy and distance, without substantially increasing the size of the case or cartridge.

The present invention provides a method for chambering a barrel of a gun comprising the steps of: providing a chamber reamer comprising a shank extending longitudinally between a front end and a rear end and having a plurality of cutting flutes disposed between the front end and the rear end; a shaft extending to the rear end of the shank and adapted to rotate the shank along an interior of the barrel to form a chamber therein, wherein the shank comprises a body region that extends to a shoulder region that transitions to a case mouth that extends to a throat connected to a free bore, wherein the body region comprises a rear diameter near the breech face of about 0.4718; and a body shoulder junction diameter of about 0.4625; wherein the shoulder region comprises a shoulder case mouth junction diameter is between 0.31 to 0.32; a breech face to lead-in bore junction length of between 2.1 to 2.2; a breech face to body-shoulder junction length of between 1.80-1.85; and a breech face to shoulder neck junction length of between 1.9-2.0; aligning the chamber reamer with a barrel in which a chamber is to be formed; rotating the chamber reamer; and pushing the chamber reamer into the barrel to from a chamber in the barrel.

In one embodiment the method, further comprises the step of analyzing the chamber to determine a chamber dimension. In one embodiment the method, further comprises the step of comparing the chamber dimension to a standard chamber dimension. In one embodiment the method, wherein the shoulder case mouth junction diameter is 0.3169. In one embodiment the method, wherein the breech face to lead-in bore junction length of about 2.2272. In one embodiment the method, wherein the breech face to body-shoulder junction length of about 1.8229. In one embodiment the method, wherein the breech face to shoulder neck junction length of about 1.9490. In one embodiment the method, wherein the shoulder taper angle is about 30 degrees. In one embodiment the method, wherein the front end has a diameter less than the diameter of the shank. In one embodiment the method, wherein the shaft is adapted to be matingly received within the front end of the shank to transfer rotation to the shank. In one embodiment the method, wherein the shaft is adapted to be matingly received within the rear end of the shank to transfer rotation to the shank. In one embodiment the method, wherein the shank is substantially cylindrical. In one embodiment the method, wherein the rotating is done manually by turning a handle and a shaft to rotate the shank. In one embodiment the method, wherein the rotating is automated.

### BRIEF DESCRIPTION OF THE DRAWINGS

For a more complete understanding of the features and advantages of the present invention, reference is now made to the detailed description of the invention along with the accompanying figures and in which:

FIG. 1 is a side, elevation view of a nontraditional ammunition cartridge of the present invention;

FIG. 2 depict a side, cross-sectional view of a nontraditional ammunition cartridges of FIG. 1;

FIG. 3 is a perspective view of a barrel;

FIG. 4 depicts a weapon platform;

FIG. 5 is a side view of the profiles of the ammunition cartridges of FIGS. 1 and 2;

FIG. 6 is a side view of the barrel showing the chamber designed to house the ammunition cartridges of FIGS. 1 and 2; and

FIGS. 7a and 7b are schematic illustrations of a reamer for use in preparation of a chamber to use the ammunition cartridges of FIGS. 1 and 2.

It is to be noted however, that the appended drawings illustrate only a typical embodiment of this invention and are therefore not to be considered limiting of its scope, for the invention may admit to other equally effective embodiments.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The polymeric ammunition cartridges used in the cartridge chamber of the present invention are of a caliber typically carried by soldiers in combat for use in their combat weapons and common in the sporting field. The present invention is not limited to the described caliber and is believed to be applicable to other calibers as well. This includes various small and medium caliber munitions, including 5.45 mm, 5.56 mm, 6.5 mm, 6.8 mm, 7 mm, 7.62 mm, 8 mm, 9 mm, 10 mm, 12.7 mm, 14.5 mm, 20 mm, 25 mm, 30 mm, 40 mm, .17 caliber, .22 caliber, .243 caliber, .257 caliber, .270 caliber, .277 caliber, .30 caliber, .303 caliber, .308 caliber, .338 caliber, .357 caliber, .38 caliber, .375 caliber, .40 caliber, .416 caliber, .43 caliber, .44 caliber, .45 caliber, .475 caliber, and .50 caliber ammunition, cases, cartridges and components of ammunition, cases, cartridges. The chamber can be sized and dimensioned to receive any of the calibers listed above. The ammunition and ammunition cartridge as well as the nose and base used to assemble the ammunition and the cartridge have the specific size, shape and dimensions based on the caliber and chamber of the gun in which it is chambered. The chamber and the ammunition mate such that they have the same characteristics. The specific neck, shoulder, case diameter projectile aperture, and case length match with the corresponding cartridge chamber. In other embodiments of the instant application, the ammunition and ammunition cartridge as well as the nose and base used to assemble the ammunition and the cartridge have a nonstandardized size, shape and dimensions as described and illustrated herein. In one embodiment the nonstandardized size, shape and dimensions of the ammunition results from the nose having a nonstandardized size and shape to the shoulder of the nose and to the nonstandardized size of the neck.

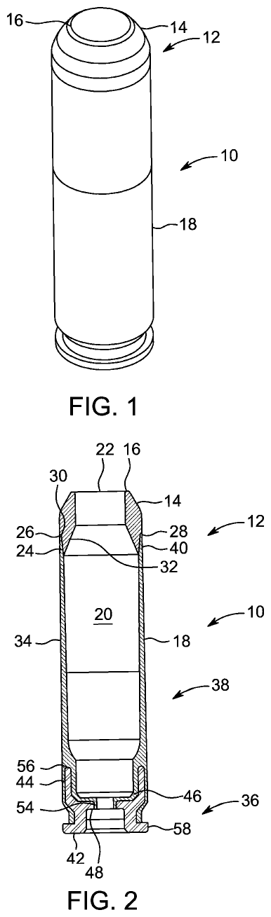

FIG. 1 illustrates an ammunition cartridge 10 having a nonstandardized size, shape and dimensions resulting from the nose 12 having a nonstandardized size and shape to the shoulder 14 of the nose and to the nonstandardized size of the neck 16 and a cartridge body 18. As used herein the term neck is defined as the opening at the top of the cartridge where the projectile sits. In a traditional cartridge the neck is a cylindrical portion above the shoulder that supports the projectile and the opening in which the projectile is placed is referenced as the case mouth. As the instant cartridge does not have a traditional neck the shoulder transitions into the case mouth. The term neck and case mouth define the same region in the instant cartridge and may be used interchangeably herein.

FIG. 2 depicts a side, cross-sectional view of a polymeric cartridge 10 having a nonstandardized size, shape and dimensions resulting from the nose 12 having a nonstandardized size and shape to the shoulder 14 of the nose and to the nonstandardized size of the neck 16. A polymeric cartridge 10 suitable for use with high velocity rifles is shown manufactured with a nose 12 and a cartridge body 18 forming a powder chamber 20. The nose 12 includes a projectile aperture 22 that is in communication with a neck 16 that is in communication with a shoulder 14 that extends to a body coupler 24. The body coupler 24 mates to the body 18 a nose joint 26. The body coupler 24 may have various configurations including lap joints half lap joints and overlapping joints. The illustrated joint includes a relative flat surface 30 that mates to the nose coupler 28 at the top of the cartridge body 18. A lip 32 is positioned in communication with the flat surface 30 to contact the cartridge body 18.

In other embodiments the flat surface 30 may be sloped, angled or having an alignment aid that mates a corresponding feature on the cartridge body 18 to locate and align the nose 12. The cartridge body 18 extends a side wall 34 from the nose joint 26 toward a base end 36. A projectile (not shown) may be inserted into the projectile aperture 22. The polymeric cartridge 10 has a substantially cylindrical open-ended polymeric nose 12 extending from the projectile aperture 22 rearward to body coupler 24. Body coupler 24 is shown as an overlapping joint but may also be configured as a male element in alternate embodiments of the invention. The nose 12 has a shoulder 14 forming chamber neck 16. The nose 12 typically has a wall thickness that is thickened to accept and contact the projectile. The cartridge body 38 is connected to the nose 12 at the nose joint 26 by mating the body coupler 24 to the nose coupling element 40 of the cartridge body 38.

The cartridge body 38 extends to and overmolds a primer insert 42 to complete the bottom of the polymeric cartridge 10. The primer insert 42 includes a coupling element 44 extending from an insert bottom surface 46 that is opposite an insert top surface 48. When contacted the polymer overmolding interlocks with the coupling element 44, through the coupling element 44 that extends with a taper to a smaller diameter at the tip 56 to form a physical interlock between the primer insert 42 and the side wall 34. Located in the insert top surface 48 is a primer recess 50 that extends toward the insert bottom surface 46. A primer flash hole 52 is located in the primer recess 50 and extends through the insert bottom surface 46 into the powder chamber 20. The coupling element 44 extends the polymer through the primer flash aperture 52 to form a primer flash hole 54 while retaining a passage from the insert top surface 48 through the bottom surface 46 and into the powder chamber 20 to provide support and protection about the primer flash hole 54. A groove 56 is positioned around the primer flash aperture 52 in the primer recess 50 to accept the polymer overmolding once it extends through the primer flash aperture 52 to form a primer flash hole 54. The primer insert 42 also has an extraction flange 58 positioned about the insert top surface 48 at the bottom of the polymeric cartridge 10. The primer insert 42 includes the primer recess 50 formed in the insert top surface 48 for ease of insertion of the primer (not shown). The primer recess 38 is sized so as to receive the primer (not shown) in an interference fit during assembly. A primer flash hole 54 communicates through the insert bottom surface 46 of the primer insert 42 into the powder chamber 20 so that upon detonation of primer (not shown) the powder in powder chamber 20 will be ignited.

The nose 12, the side wall 34 and primer insert 42 define the interior of powder chamber 20 in which the powder charge (not shown) is contained. The interior volume of powder chamber 20 may be varied to provide the volume necessary for complete or partial filling of the powder chamber 20 by the propellant chosen so that a simplified volumetric measure of propellant can be utilized when loading the cartridge. Either a particulate or consolidated propellant can be used.

Projectile (not shown) is held in place within projectile aperture 22 by an interference fit. Mechanical crimping of the projectile aperture 22 can also be applied to increase the bullet pull force. The bullet (not shown) may be inserted into place following the completion of the filling of powder chamber 20. Projectile (not shown) can also be injection molded directly onto the projectile aperture 22 or may be secured by welding or bonding together using solvent, adhesive, spin-welding, vibration-welding, ultrasonic-welding or laser-welding techniques. The welding or bonding increases the joint strength so the casing can be extracted from the hot gun casing after firing at the cook-off temperature.

The nose 12 and can then be welded or bonded together using solvent, adhesive, spin-welding, vibration-welding, ultrasonic-welding or laser-welding techniques. The welding or bonding increases the joint strength so the casing can be extracted from the hot gun casing after firing at the cook-off temperature. An optional first and second annular grooves (cannelures) may be provided in the bullet-end in the interlock surface of the male coupling element to provide a snap-fit between the two components. The cannelures formed in a surface of the bullet at a location determined to be the optimal seating depth for the bullet. Once the projectile (not shown) is inserted into the projectile aperture 22 to the proper depth to lock the bullet in its proper location. One method is the crimping of the entire end of the casing into the cannelures.

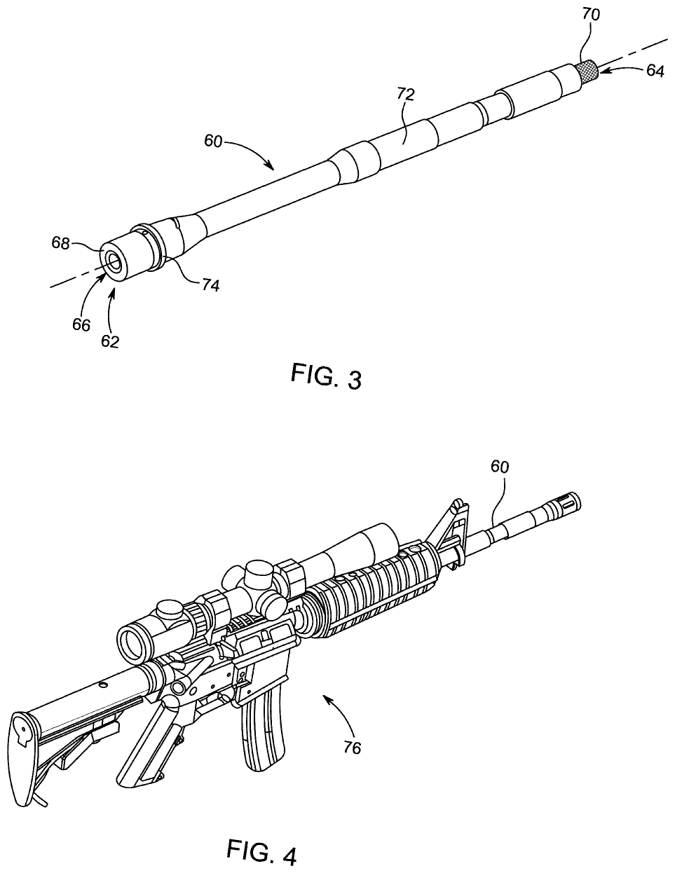

Referring to FIG. 3, the barrel 60 may include a breech end 62 and a muzzle end 64. The breech end 62 may include a breech (i.e., a chamber opening) 66 and a surrounding breech face 68. Areas of the barrel 164 adjacent to muzzle end 64 may be threaded 70 for receiving a flash hider, compensator, suppressor, or other suitable tactical accessory or part. Although, the radial dimension of the barrel's exterior surface 72 may vary along the length of the barrel, the barrel's exterior surface may have generally constant radial dimension. Spaced from the breech end, however, may be a circumferential ring 74 that may be formed integrally with the barrel. The circumferential ring 74 may be a locking ring that may be used to secure the barrel 60 to an upper receiver of the firearm.

FIG. 4 depicts a weapon platform 76 that is configured for 6.8 mm ammunition. The barrel 60 of the AR-15/M4 weapon platform, however, may be chambered for the ammunition cartridge of FIGS. 1 and 2. The barrel 60 may be configured for straight blowback operation. The weapon platform 76 may be capable of semi-automatic and full automatic modes.

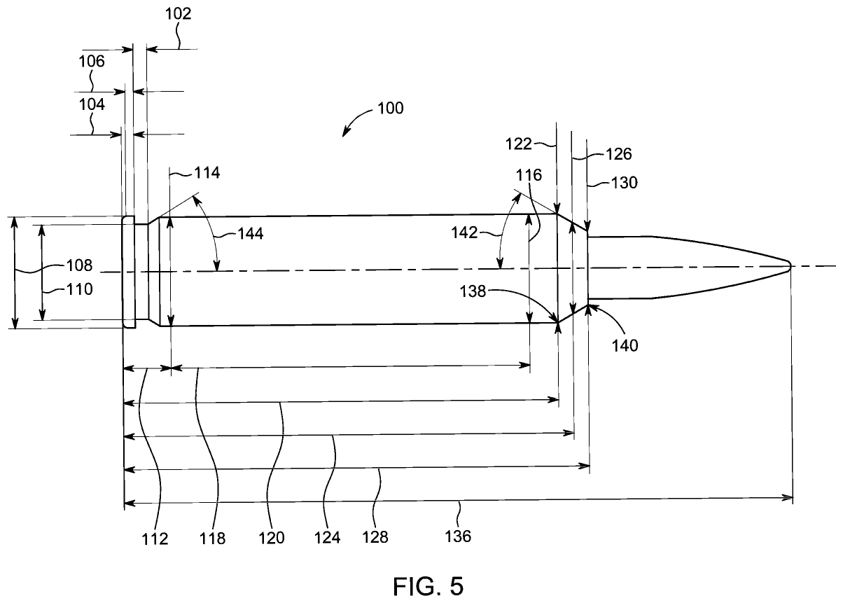

FIG. 5 is a side view of the profiles of the ammunition cartridges of FIGS. 1 and 2. The ammunition cartridge chamber that utilizes the polymeric cartridge 100 of FIGS. 1 and 2 may have nominal dimensions intended to establish a standard cartridge type. Variations from the nominal dimensions may be tolerated by limited amounts. For example, diameters in FIG. 5 may have a tolerance of between +0.020 and −0.020 inch which means each and every value from +0.020 to −0.020, except as otherwise noted. Below are an exemplary set of nominal dimensions and tolerances for the standard cartridge type of FIGS. 1 and 2. The polymeric cartridge 10 has an Extraction groove thickness 102 (L_{eg}) of 0.065±0.020 and an Overall Rim thickness 104 (L_{RMT}) of 0.054±0.020 with a Rim thickness 106 (L_{RM}) 0.410±0.020. The Rim diameter 108 (D_{RIM}) is 0.473±0.020 and the diameter of the Head Face/Extraction groove 110 (D_{HF/EG}) is 0.405±0.020. The length from the extractor the head face to the body 112 (L_{HFB}) is 0.200±0.020. The polymeric cartridge 100 has a Base diameter 114 (D_{B}) of 0.4705±0.020 and a nose joint diameter 116 (D_{NJ}) of 0.4636±0.020 with a Cartridge Body Length 118 (L_{CB}) of 1.500±0.020 from the 0.200 from the head face to the Nose Joint. The polymeric cartridge 100 has an axial length from head face to base-shoulder junction 120 (L_{HBSJ}) of 1.8225±0.020 and a base-shoulder junction diameter 122 (D_{BSJ}) of 0.4630±0.020. The polymeric cartridge 100 has an axial length from head face to mid-shoulder 124 (L_{HMS}) of 1.8840±0.020 and a diameter at the mid-shoulder 126 (Dₘₛ) of 0.392±0.020. The polymeric cartridge 100 has an axial length from head face to shoulder-neck junction 128 (L_{HSNJ}) of 1.9530±0.020. As the polymeric cartridge 100 has a shoulder-neck junction diameter 130 (D_{SNJ}) of 0.318±0.020. The axial length from head face to shoulder-neck junction 128 (L_{HSNJ}) is the same as the case length 134 (L_{CL}) of 1.9530±0.020. The total cartridge length 136 (L_{TC}) is between 2.685 and 2.810±0.20. The polymeric cartridge 100 has a radius of circular curve, convex segment 138 (round) (R₁) of 0.140±0.020 and a radius of circular curve, concave segment 140 (fillet) (R₂) of 0.006±0.020. The polymeric cartridge 100 has a shoulder taper angle 142 (α₁) of 30°±3 and a head taper angle 144 (α₂) of 36°±6.

The ammunition cartridge 100 of FIGS. 1 and 2 may have nominal dimensions intended to establish a standard cartridge type and these cartridge dimensions will dictate the chamber dimensions defined in the barrel. As a result, the chamber in the barrel will have dimensions that are slightly larger than the dimensions of the ammunition cartridge to accommodate the ammunition cartridge 100. Thus the dimensions of the chamber may be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 percent more than the nominal dimensions of the ammunition cartridge.

Nominal Dimensions for Exemplary Cartridge
Nominal Dimensions for Exemplary Cartridge

| Description | | | Dimension | Tolerance± |
|---|---|---|---|---|
| Extraction groove thickness | 102 | L_{EG} | 0.065 | 0.020 |
| Overall rim thickness, | 104 | L_{RMT} | 0.054 | 0.020 |
| Rim thickness | 106 | L_{RM} | 0.410 | 0.020 |
| Rim diameter | 108 | D_{RIM} | 0.473 | 0.020 |
| Axial length from head face to | 110 | D_{HF/EG} | 0.405 | 0.020 |
| extraction groove | | | | |
| Axial length from the head | 112 | L_{HFB} | 0.200 | 0.020 |
| face to the body | | | | |
| Diameter at the base | 114 | D_{B} | 0.4705 | 0.020 |
| Diameter of the cartridge | 116 | D_{cb} | 0.4636 | 0.020 |
| body | | | | |
| Axial length from of the | 118 | L_{CB} | 1.500 | 0.020 |
| cartridge body | | | | |
| Axial length from the head | 120 | L_{HBSJ} | 1.8225 | 0.200 |
| face to the shoulder | | | | |
| Diameter at the base-shoulder | 122 | D_{BSJ} | 0.4630 | 0.020 |
| junction | | | | |
| Axial length from the head | 124 | L_{HMS} | 1.884 | 0.020 |
| face to the mid-shoulder | | | | |
| Diameter at the mid-shoulder | 126 | Dₘₛ | 0.392 | 0.020 |
| Axial length from the head | 128 | L_{HSNJ} | 1.9530 | 0.020 |
| face to the neck | | | | |
| Diameter at the shoulder-neck | 130 | D_{SNJ} | 0.318 | 0.020 |
| junction | | | | |
| Axial case length | 134 | L_{CL} | 1.9530 | 0.020 |
| Axial cartridge length | 136 | L_{TC} | 2.685-2.81 | 0.200 |
| Radius of circular curve, | 138 | R1 | 0.140 | 0.020 |
| convex segment (round) | | | | |
| Radius of circular curve, | 140 | R2 | 0.006 | 0.020 |
| concave segment (fillet) | | | | |
| Shoulder taper angle | 142 | α₁ | 30° | 3 |
| Head taper angle | 144 | α₂ | 36° | 6 |

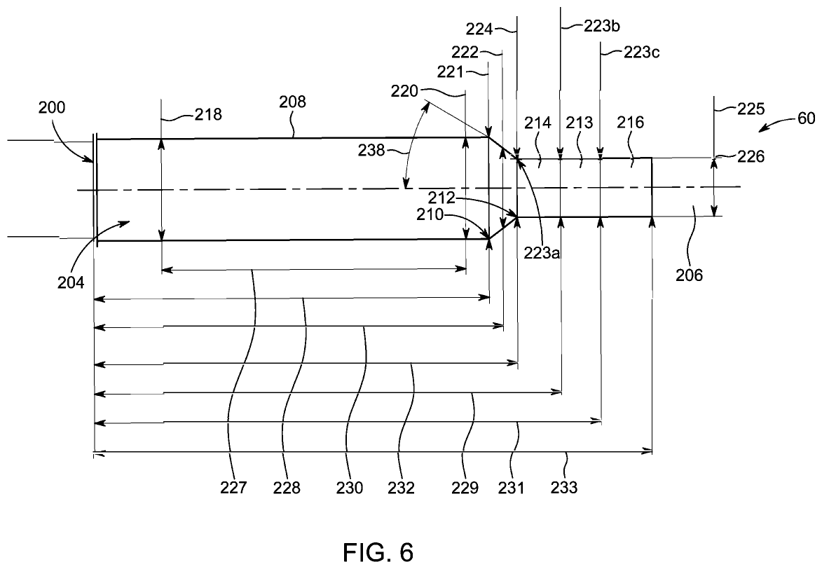

Referring to FIG. 6, the barrel 60 may include a breech face 200, a breech 202 that provides access to the chamber 204 that extends to a bore 206. The chamber 204 may be configured and dimensioned in accordance with FIG. 5, and thus may include a profile that comprises a body segment 208, a shoulder segment 210, a neck segment 212, a throat segment 214, a free bore segment 213 and a lead in segment 216 including grooves (not shown). The barrel 60, however, may include an optional tapered feed section (not shown) disposed between the breech face 200 and the body segment 208 of the chamber 204. The feed section (not shown) may facilitate loading of ammunition cartridges into the chamber due to the increased diameter of the feed section (not shown) at the breech 202. The barrel 60 includes a breech face 200 that extends to a chamber 208 which has a chamber diameter 0.200 from the bolt face 218 (D_{NBF}) of 0.4718±0.020 and a chamber diameter near the shoulder 220 (D_{NS}) of 0.4636±0.020. In the chamber 208, the diameter at the body shoulder junction 221 (D_{BSJ}) is 0.4629±0.020 with the diameter at the shoulder mid-point 222 (D_{SM}) 0.392±0.020 and the diameter at the shoulder neck junction 224 (D_{SNJ}) is 0.3169±0.020. The diameter at the throat neck junction 223a (D_{TNJ}) is 0.2896±0.020 and the diameter at the throat free-bore junction 223b (D_{TFJ}) is 0.2778±0.020 and the diameter at the free-bore lead-in junction 223c (D_{FLJ}) is 0.2778±0.020. The bore diameter 225 (D_{B}) is 0.270±0.020 and the groove diameter 226 (D_{BG}) is 0.277±0.020.

The chamber 208 has a case length 227 (L_{NBFSJ}) from the 0.20 from the breech face 200 to the body shoulder junction of 1.500±0.020. The chamber 208 has a case length 228 (L_{BSJ}) from the breech face 200 to the body shoulder junction of 1.8229±0.020 and a mid shoulder length 230 (L_{BMs}) from the breech face 200 to the mid-shoulder of between 1.884 to 1.894±0.020 with a length from the breech face 200 to the shoulder neck junction 232 (L_{BSNJ}) of 1.9490±0.020. The chamber 208 has a case length 229 (L_{BTFJ}) from the breech face 200 to the throat free-bore junction is 2.066±0.020. The chamber 208 has a case length 231 (L_{BFLJ}) from the breech face 200 to free-bore lead-in junction is 2.206±0.020. The chamber 208 has a case length 233 (L_{BSJ}) from the breech face 200 to lead-in bore junction is 2.355±0.020. The chamber 208 has a Radius of concave circular curve 234 (R₁) of 0.140±0.030 and a Radius of convex circular curve 236 (R₂) of 0.014 to 0.08±0.020. The chamber 208 has a shoulder taper angle 238 (α₁) of 30°+3.

Nominal Dimensions for Exemplary Cartridge Chamber

| Description | | | Dimension | Tolerance± |
|---|---|---|---|---|
| Chamber diameter near the | 218 | D_{NBF} | 0.4718 | 0.020 |
| breech face | | | | |
| Chamber diameter near | 220 | D_{NS} | 0.4636 | 0.020 |
| the shoulder | | | | |
| Chamber diameter at the | 221 | D_{BSJ} | 0.4629 | 0.020 |
| body shoulder junction | | | | |
| Chamber diameter at the | 222 | D_{SM} | 0.3920 | 0.020 |
| shoulder mid-point | | | | |
| Chamber diameter at the | 224 | D_{SNJ} | 0.3169 | 0.020 |
| shoulder neck junction | | | | |
| Chamber diameter at the | 223a | D_{TNJ} | 0.2896 | 0.020 |
| throat neck junction | | | | |
| Chamber diameter at the | 223b | D_{TFJ} | 0.2778 | 0.020 |
| throat free bore junction | | | | |
| Chamber diameter at the | 223c | D_{FLJ} | 0.2778 | 0.020 |
| free bore lead in junction | | | | |
| Chamber diameter of the | 225 | D_{B} | 0.2700 | 0.020 |
| bore | | | | |
| Diameter of the groove | 226 | D_{BG} | 0.2770 | 0.020 |
| Axial length from near | 227 | L_{NBFSJ} | 0.1500 | 0.020 |
| breech face to the body | | | | |
| shoulder junction | | | | |
| Axial length from breech | 228 | L_{BSJ} | 1.8229 | 0.020 |
| face to body-shoulder | | | | |
| junction | | | | |
| Axial length from breech | 230 | L_{BMS} | 1.884-1.894 | 0.020 |
| face to mid-shoulder | | | | |
| Axial length from breech | 229 | L_{BTFJ} | 2.066 | |
| face to the throat free-bore | | | | |
| junction | | | | |
| Axial length from breech | 231 | L_{BFLJ} | 2.206 | |
| face to free-bore lead-in | | | | |
| junction | | | | |
| Axial length from breech | 233 | L_{BSJ} | 2.355 | |
| face to lead-in bore junction | | | | |
| Axial length from breech | 232 | L_{BSNJ} | 1.9490 | 0.020 |
| face to shoulder neck | | | | |
| junction | | | | |
| Radius of circular curve, | 234 | R₁ | 0.140 | 0.020 |
| convex segment (round) | | | | |
| Radius of circular curve, | 236 | R₂ | 0.014-0.008 | 0.020 |
| concave segment (fillet) | | | | |
| Radius of circular curve, | 234 | R₃ | 0.005 | 0.020 |
| convex segment (round) | | | | |
| Shoulder taper angle | 238 | α1 | 30° | 3 |

Although the body segment 208 may be shorter in length than disclosed, the diameter D_{BSJ} at the base-shoulder junction may be positioned at the same distance L_{BSJ} from the breech face 200. Similarly, the chamber 204 may have the same headspace dimensions (i.e., Axial length from breech face 200 to shoulder neck junction L_{BSNJ} and diameter at the shoulder neck junction D_{SNJ}) and shoulder geometry as disclosed in FIG. 5. Additionally, the neck segment 212 and throat segment 214 may be configured and dimensioned as necessary.

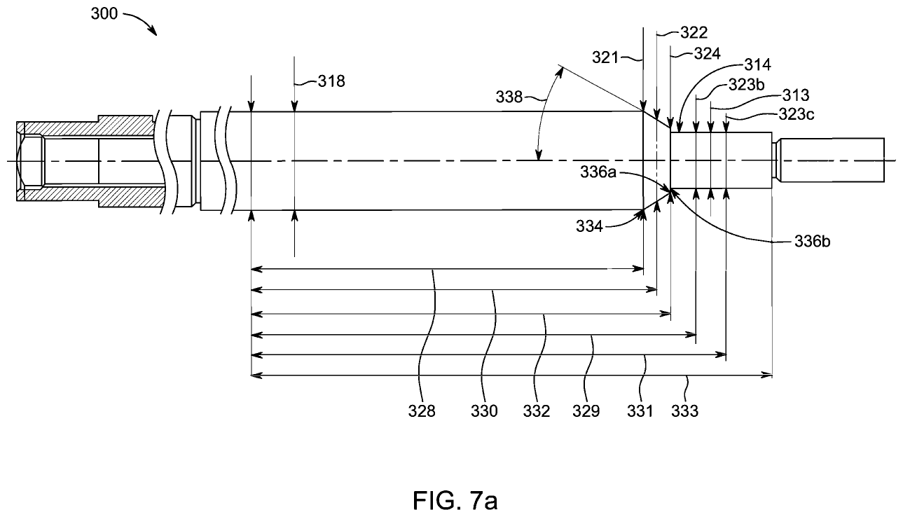

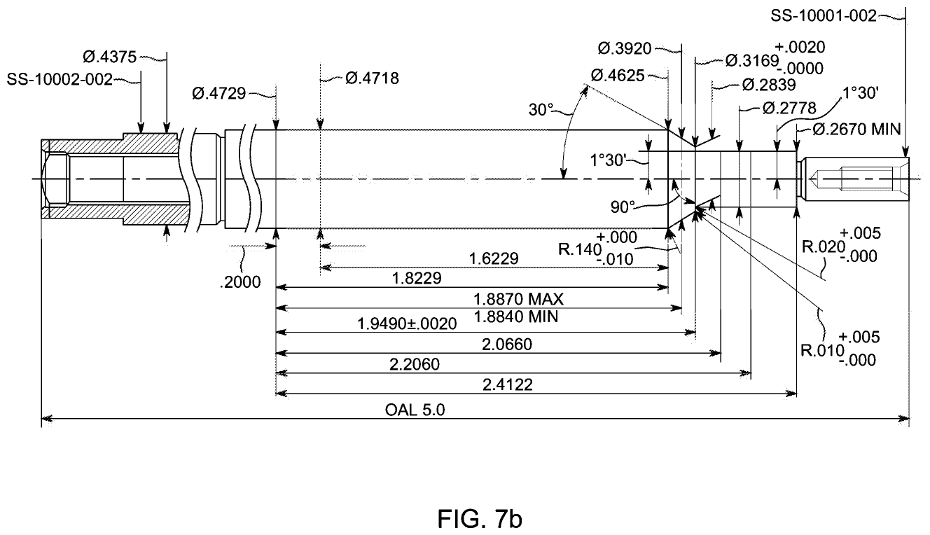

FIGS. 7a and 7b are schematic illustrations of a reamer for use in preparation of a chamber to use the ammunition cartridges of FIGS. 1 and 2. The reamer 300 is illustrated that is specifically designed to ream or form a firearm chamber compatible with cartridge illustrated in FIGS. 1 and 2. The values listed in FIG. 7 may be 10% larger or 10% smaller allow for tolerances. The dimensions listed may also be ±0.02. It will be noted that the chamber has dimensions slightly larger than an unfired in FIGS. 1 and 2. When cartridge is fired in the chamber formed with reamers 300 the fired dimensions set forth above are achieved.

Nominal Dimensions for Exemplary Chamber Reamer

| Description | | | Dimension | Tolerance± |
|---|---|---|---|---|
| Reamer diameter near | 318 | D_{NBF} | 0.4718 | 0.020 |
| the breech face | | | | |
| Reamer diameter at the | 321 | D_{BSJ} | 0.4625 | 0.020 |
| body shoulder junction | | | | |
| Reamer diameter at the | 322 | D_{SM} | 0.3920 | 0.020 |
| shoulder mid-point | | | | |
| Reamer diameter at the | 324 | D_{SNJ} | 0.3169 | 0.020 |
| shoulder neck junction | | | | |
| Reamer diameter at the | 323b | D_{TFJ} | 0.2778 | 0.020 |
| throat free bore | | | | |
| junction | | | | |
| Reamer diameter at the | 323c | D_{FLJ} | 0.2690 | 0.020 |
| free bore lead in | | | | |
| junction | | | | |
| Axial length from | 328 | L_{BSJ} | 1.8229 | 0.020 |
| breech face to body- | | | | |
| shoulder junction | | | | |
| Axial length from | 330 | L_{BMS} | 1.887-1.884 | 0.020 |
| breech face to mid- | | | | |
| shoulder | | | | |
| Axial length from | 329 | L_{BTFJ} | 2.021 | 0.020 |
| breech face to the | | | | |
| throat free-bore | | | | |
| junction | | | | |
| Axial length from | 331 | L_{BFLJ} | 2.189 | 0.020 |
| breech face to free- | | | | |
| bore lead-in junction | | | | |
| Axial length from | 333 | L_{BSJ} | 2.2272 | 0.020 |
| breech face to lead- | | | | |
| in bore junction | | | | |
| Axial length from | 332 | L_{BSNJ} | 1.9490 | 0.020 |
| breech face to shoulder | | | | |
| neck junction | | | | |
| Radius of circular | 334 | R₁ | 0.140 | 0.020 |
| curve, convex | | | | |
| segment (round) | | | | |
| Radius of circular | 336a | R₂ | 0.014-0.008 | 0.020 |
| curve, concave | | | | |
| segment (fillet) | | | | |
| Radius of circular | 336b | R₃ | 0.020-0.005 | 0.020 |
| curve, concave | | | | |
| segment (fillet) | | | | |
| Shoulder taper angle | 338 | α1 | 30° | 3 |

The reamer 300 may be configured and dimensioned to form the chamber illustrated in FIG. 6. The reamer 300 has a chamber diameter at the chamber's bolt face end 318 (D_{NBF}) of 0.4718±0.020. The reamer 300 has a diameter at the body shoulder junction 321 (D_{BSJ}) is 0.4625±0.020 with the diameter at the shoulder mid-point 322 (D_{SM}) 0.392±0.020 and the diameter at the shoulder neck junction 324 (D_{SNJ}) is 0.3169±0.020. The diameter at the throat free-bore junction 323b (D_{TFJ}) is 0.2778±0.020 and the diameter at the free-bore lead-in junction 323c (D_{FLJ}) is 0.2690±0.020.

The reamer 300 has a case length 328 (L_{BSJ}) from the breech face region to the body shoulder junction of 1.8229±0.020 and a mid shoulder length 330 (L_{BMS}) from the breech face region to the mid-shoulder of between 1.887 to 1.884±0.020 with a length from the breech face region to the shoulder neck junction 332 (L_{BSNJ}) of 1.9490±0.020. The reamer 300 has a case length 329 (L_{BTFJ}) from the breech face region to the throat free-bore junction is 2.021±0.020. The reamer 300 has a case length 331 (L_{BFLJ}) from the breech face region to free-bore lead-in junction is 2.189±0.020. The reamer 300 has a case length 333 (L_{BSJ}) from the breech face region to lead-in bore junction is 2.2272±0.020. The reamer 300 has a Radius of concave circular curve 334 (R₁) of 0.140±0.030 and a Radius of convex circular curve 236a (R₂) of 0.010±0.020. Radius of circular curve 236b of 0.020±0.020. The reamer 300 has a shoulder taper angle 238 (α₁) of 30°+3.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A method for chambering a barrel of a gun comprising the steps of:
providing a chamber reamer comprising
a shank extending longitudinally between a front end and a rear end and having a plurality of cutting flutes disposed between the front end and the rear end;
a shaft extending to the rear end of the shank and adapted to rotate the shank along an interior of the barrel to form a chamber therein, wherein the shank comprises a body region that extends to a shoulder region that transitions to a case mouth that extends to a throat connected to a free bore, wherein the body region comprises
a rear diameter near the breech face of about 0.4718; and
a body shoulder junction diameter of about 0.4625;
wherein the shoulder region comprises
a shoulder case mouth junction diameter is between 0.3100-0.3200;
a breech face to lead-in bore junction length of between 2.1000-2.2000;
a breech face to body-shoulder junction length of between 1.8000-1.8500; and
a breech face to shoulder neck junction length of between 1.9000-2.0000;
aligning the chamber reamer with a barrel in which a chamber is to be formed;
rotating the chamber reamer; and
pushing the chamber reamer into the barrel to from a chamber in the barrel.

2. The method of claim 1, further comprising the step of analyzing the chamber to determine a chamber dimension.

3. The method of claim 1, further comprising the step of comparing the chamber dimension to a standard chamber dimension.

4. The method of claim 1, wherein the shoulder case mouth junction diameter is 0.3169.

5. The method of claim 1, wherein the breech face to lead-in bore junction length of about 2.2272.

6. The method of claim 1, wherein the breech face to body-shoulder junction length of about 1.8229.

7. The method of claim 1, wherein the breech face to shoulder neck junction length of about 1.9490.

8. The method of claim 1, wherein the shoulder taper angle is about 30 degrees.

9. The method of claim 1, wherein the front end has a diameter less than the diameter of the shank.

10. The chambering reamer of claim 1, wherein the shaft is adapted to be matingly received within the front end of the shank to transfer rotation to the shank.

11. The chambering reamer of claim 1, wherein the shaft is adapted to be matingly received within the rear end of the shank to transfer rotation to the shank.

12. The chambering reamer of claim 1 wherein the shank is substantially cylindrical.

13. The chambering reamer of claim 1 wherein the rotating is done manually by turning a handle and a shaft to rotate the shank.

14. The chambering reamer of claim 1 wherein the rotating is automated.
